(19) United States
(12) Patent Application Publication
(10) Pub. No.: US 2022/0258428 A1
(43) Pub. Date: Aug. 18, 2022

(54) METHOD OF DETERMINING A LOCAL HEIGHT OF A BUILD SURFACE

(71) Applicant: Ultimaker B.V., Utrecht (NL)

(72) Inventors: Peter Brier, Utrecht (NL); Kornelis Hermanus Welling, Utrecht (NL)

(73) Assignee: Ultimaker B.V., Utrecht (NL)

(21) Appl. No.: 17/629,795

(22) PCT Filed: Jul. 14, 2020
(86) PCT No.: PCT/NL2020/050463

§ 371 Date: Jan. 25, 2022

(30) Foreign Application Priority Data
Jul. 30, 2019 (NL) 2023591

(51) Int. Cl. B29C 64/393; G01B 13/22; B33Y 50/02; B33Y 30/00; B29C 64/245

(52) U.S. Cl. CPC B29C 64/393; G01B 13/22; B29C 64/118; B33Y 30/00; B29C 64/245; B33Y 50/02

(57) ABSTRACT

The invention relates to a fused filament fabrication device (1) comprising a print head (2) comprising a melt chamber (22) and a nozzle (4). The print head (2) is movably arranged relative to a build surface (10) in at least two perpendicular directions. A feeder (3) is arranged to feed filament material to the print head (2). A sensor is arranged to directly or indirectly measure a pressure in the melt chamber (22), the sensor producing pressure data. A flow sensor is arranged to measure a flow of filament into the print head (2) to obtain flow data. The device (1) also comprises a controller (7) arranged for a) controlling movement of the nozzle (4) over the build surface (10), b) controlling deposition of molten filament material on the build surface (10) during the movement of the nozzle (4), c) receiving the pressure data and the flow data, and d) determining a local height of the build surface (10) fora plurality of locations on the build surface (10), using the pressure data and the flow data.

### FIELD OF THE INVENTION

The present invention relates to a fused filament fabrication device and to a method of determining a local height of a build surface of a build plate for use in such a fused filament fabrication device. The invention also relates to a computer program product.

### BACKGROUND ART

Fused filament fabrication (FFF) is a 3D printing process that uses a continuous filament of a thermoplastic material. Filament is fed from a coil through a moving, heated print head, and is deposited through a print nozzle on the growing work. The print head may be moved under computer control to define a printed shape. Usually the print head moves in two dimensions to deposit one horizontal plane, or layer, at a time. The work or the print head is then moved vertically by a small amount to begin a new layer.

In FFF 3D printing the distance between the print nozzle and the build surface where the first layer of material is deposited, is a critical parameter that needs to be controlled to tight tolerances. Typically a distance of 50 to 500 μm needs to be controlled to within a few percent of that distance. Often the build surface and nozzle have manufacturing tolerances and variations in the equipment (due to thermal elongation, bending, etc.) which lead to changes in the distance of the nozzle to the build surface that are not constant. These need to be measured prior to printing.

To measure a local height of the build surface, a mechanical probe could be used (similar to a touch probe in CNC or CMM equipment), but this adds weight to the print head and also increases costs.

### SUMMARY OF THE INVENTION

An object of the present invention is to provide a fused filament fabrication device in which at least some of the problems of the prior art are solved.

According to a first aspect, there is provided a fused filament fabrication device, the device comprising a print head comprising a melt chamber and a nozzle, the print head being movably arranged relative to a build surface in at least two perpendicular directions. The device further comprises a feeder arranged to feed filament material to the print head. The device also comprises a sensor arranged to directly or indirectly measure a pressure in the melt chamber, the sensor producing pressure data. The device also comprises a flow sensor arranged to measure a flow of filament into the print head to obtain flow data. Finally, the device comprises a controller arranged for:

a) controlling movement of the nozzle over the build surface;

b) controlling deposition of molten filament material on the build surface during the movement of the nozzle;

c) receiving the pressure data and the flow data, and
d) determining a local height of the build surface for a plurality of locations on the build surface, using the pressure data and the flow data.

When a molten filament, such as a molten polymer, is forced through a nozzle orifice that is covered by the build surface, a pressure will be present behind the orifice that is a function of the flow and the flow resistance. This flow resistance is depending on the resistance of the nozzle and the resistance of the gap between the nozzle and the surface. The latter is a function of the distance between the build surface and the nozzle. This principle is known as the flapper-nozzle mechanism. By utilizing this principle to measure the distance between the build surface and the nozzle of an FFF printer, a robust low cost height measurement system can be built. The pressure changes are measured either directly in the melt chamber, or (indirectly) by measuring the forces acting on the filament or the reaction force of the nozzle between the nozzle and the build surface. Even more indirectly, the driving torque of a feeder motor can be used to estimate the pressure in the melt chamber.

In an embodiment, the controller is arranged to vary a flow of the filament material into the print head during printing in such a way as to maintain a constant pressure in the melting chamber, wherein the controller is arranged to determine the local height based on the varying feed flow.

In an embodiment, the controller is arranged to maintain a constant flow of the filament while letting a pressure in the melt chamber vary during printing, wherein the controller is arranged to determine the local height based on the varying pressure.

In an embodiment, the controller is arranged to vary the distance between the nozzle and the build surface during printing in such a way as to maintain a constant flow of the filament and a constant pressure in the melt chamber, wherein the controller is arranged to determine the local height based on the varying distance.

In an embodiment, the controller is arranged to deposit a single layer of material along a predetermined trajectory and to determine the local height of the build plate at a plurality of locations on the trajectory.

In an embodiment, the controller is arranged to generate a height map of the build plate using the determined local height of the plurality of locations.

In an embodiment, the build surface comprises a predefined pattern of surface irregularities representing an identification of the build plate, and wherein the controller is arranged to deposit a single layer of material over the predefined pattern of surface irregularities, and to determining the local height of the predefined pattern of surface irregularities, and to translate the determined local height of the predefined pattern into an identification code for the build plate.

According to a further aspect of the invention, there is provided a method of determining a local height of a build surface of a build plate for use in a fused filament fabrication device, the device comprising a print head comprising a melt chamber and a nozzle, the device further comprising a feeder arranged to feed filament material to the print head, a sensor arranged to directly or indirectly measure a pressure in the melt chamber to obtain pressure data, and a flow sensor arranged to measure a flow of filament into the print head to obtain flow data, the method comprising:

a) controlling movement of the nozzle over the build surface;

b) controlling deposition of molten filament material on the build surface during the movement of the nozzle;

c) receiving the pressure data and the flow data, and

d) determining a local height of the build surface for a plurality of locations on the build surface, using the pressure data and the flow data.

The method may further comprise e) identifying the build plate using the determined local height of the build surface. This embodiment involves the identification of the build surface by utilizing the height measurements. The build surface is purposely equipped with recesses or raised areas that are unique for the individual build surface (or type of surface). By scanning this pattern, the identification is performed. “Bar code” style patterns are well suited for this purpose, but other patterns can be used, such as dot-code or even lettering code.

The pattern is typically placed on the perimeter of the build surface, where no object is built, so it does not interfere with the object to be built, but it can also be used in the area of the build and in that case the pattern is visible on the object. This allows identification of the build surface used by inspecting the resulting object.

The recesses or raised areas can be applied with various means to the build surface. For example, but not limited to: machining, lasering, embossing, welding or gluing.

According to a further aspect, there is provided a computer program product comprising code embodied on a computer-readable storage and configured so as when run on the controller of the above described device to perform the above described method.

### SHORT DESCRIPTION OF DRAWINGS

The present invention will be discussed in more detail below, with reference to the attached drawings, in which

FIG. 1 schematically shows a fused filament fabrication (FFF) device according to an embodiment of the invention;

FIG. 2 schematically shows a cross section of a print head depositing a layer of build material on a build plate according to an embodiment of the present invention;

FIG. 3 shows a top view of the build plate having a trace of filament material deposited along its edges;

FIG. 4 schematically shows the controller according to an embodiment;

FIG. 5 shows a flow chart of the method of determining a local height of a build surface of a build plate according to an embodiment of the invention.

### DESCRIPTION OF EMBODIMENTS

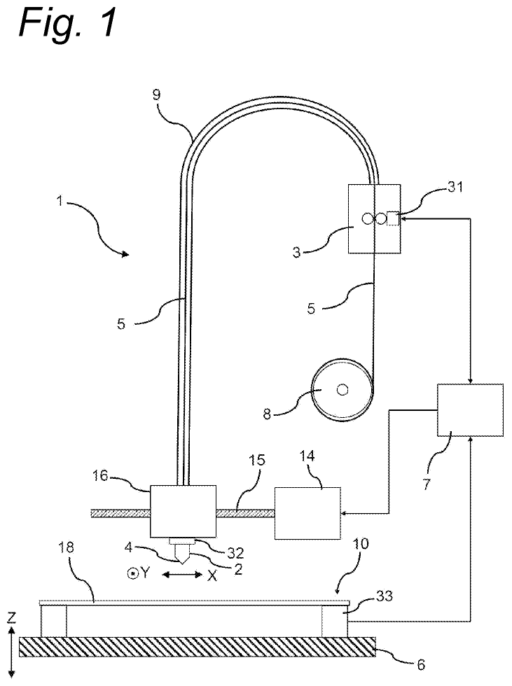

FIG. 1 schematically shows a fused filament fabrication (FFF) device 1, also referred to as the 3D printer, according to an embodiment of the invention. The 3D printer 1 comprises a print head 2 also referred to a deposition head 2. At its outer end the print head 2 comprises a nozzle 4 where molten filament leaves the deposition head 2. A filament 5 is fed into the print head 2 by means of a feeder 3. Part of the filament 5 is stored around a spool 8, which could be rotatably arranged onto a housing (not shown) of the 3D printer, or rotatably arranged within a container (not shown) containing one or more spools. The 3D printer 1 comprises a controller 7 arranged to control the feeder 3 and the movement of the print head 2, and thus of the nozzle 4. In this embodiment, the 3D printer further comprises a Bowden tube 9 arranged to guide the filament 5 from the feeder 3 to the print head 2.

The 3D printer 1 also comprises a gantry arranged to move the print head 2 at least in one direction, indicated as the X-direction. In this embodiment, the print head 2 is also movable in a Y-direction perpendicular to the X-direction. The gantry comprises at least one mechanical driver 14 and one or more axles 15 and a print head docking unit 16. The print head docking unit 16 holds the print head 2 and for that reason is also called the print head mount 16. It is noted that the print head docking unit 16 may be arranged to hold more than one print head, such as for example two print heads each receiving its own filament.

A build plate 18 may be arranged in or under the 3D printer 1 depending on the type of 3D printer. The build plate 18 may comprise a glass plate or any other object suitable as a substrate. In the example of FIG. 1, the build plate 18 is mounted on a build plate mount 6. The build plate mount 6 is movably arranged relative to the print head 2 in a Z-direction, see FIG. 1. As a consequence, the a top surface 10 of the build plate 18, also referred to as build surface 10, is movable perpendicular to the X-Y plane.

Suitable driving means (not shown) may be arranged to control the movement of the build plate mount 6. These driving means may comprise a transmission and a motor to be controlled by the controller 7 or by a separate controller.

The 3D printer 1 of FIG. 1 further comprises a flow sensor 31 which is arranged to determine a flow of the filament 5. The flow sensor 31 may comprise a circuitry arranged to measure a driving torque of an electrical motor of the feeder 3 when supplying the filament material 5 to the print head 2. Alternatively, the flow sensor 31 may comprise a wheel in contact with the filament during feeding and circuitry arranged to measure the rotation of the wheel. The flow sensor 31 is arranged to generate flow data as an output.

Alternatively or additionally, a first force sensor 32 may be arranged between the print head 2 and the print head docking unit 16 in order to measure a force on the nozzle 4, see also FIG. 1. The first force sensor 32 may comprise a piezo element, a resistive sensor, an optical sensor, a capacitive sensor or any other type of sensor arranged to generate a signal indicative of a force on the nozzle 4.

Alternatively or additionally, a second force sensor 33 may be arranged between the build plate 18 and a build plate mount 6, see FIG. 1. The second force sensor 33 may be arranged to measure a pressure on the build plate 18 which directly relates to the pressure experienced by the nozzle 4. The second force sensor 33 may comprise a piezo element, a resistive sensor, an optical sensor, a capacitive sensor or any other type of force sensor arranged to generate a signal indicative of a pressure on the build plate 18.

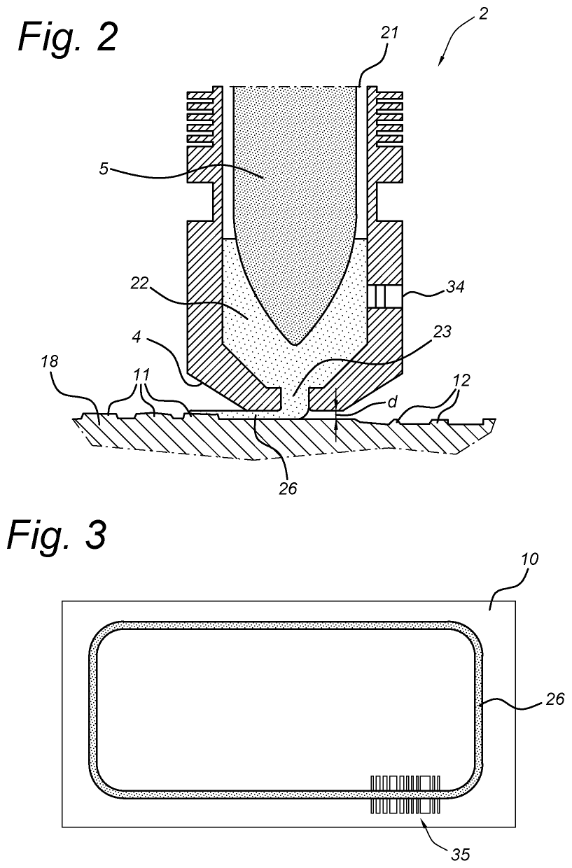

FIG. 2 schematically shows an example of the deposition head 2 having an inlet 21 for receiving the filament 5 of printable material, a melt chamber 22 and the nozzle 4 having an orifice 23 for letting out flowable printable material. The controller 7 is configured to control heating of the melt chamber 22 using a heating element (not shown). In this example, a pressure sensor 34 is arranged in the print head 2 in order to measure a pressure in the melt chamber 22 so as to obtain pressure data. The pressure sensor 34 may comprise a piezo element arranged in a wall of the melt chamber 22 so as to generate a signal indicative of a pressure inside the melt chamber 22. Other sensor technologies are possible. The generated signal contains pressure data which is communicated to the controller 7.

Please note that for reasons of simplicity in FIGS. 1 and 2 only some of the communication lines between the sensors 31, 32, 33, 34 and the controller 7 are drawn. It should be noted that communication between the one or more sensors and the controller 7 can occur via wired connections or wireless connections or a combination of the two types.

The generated flow data and the pressure data generated by the sensors can be used to determine a local height of the build surface 10 of the build plate 18 for use in a fused filament fabrication device as will be explained in more detail below.

In an embodiment of the invention, the controller 7 is arranged to determine a local height of the build surface 10 of a build plate 18 by means of:

a) controlling movement of the nozzle 4 over the build surface 10;

b) controlling deposition of molten filament material on the build surface 10 during the movement of the nozzle 4;

c) receiving the pressure data and the flow data, and

d) determining a local height of the build surface 10 for a plurality of locations on the build surface 10, using the pressure data and the flow data.

The controller 7 may be arranged to generate a height map of the build plate using the determined local height of the plurality of locations. The height map may e.g. contain relative values of the height of the surface 10 defined with reference to a zero height position. The height map can be stored and used to generate better toolpaths that will improve the reliability of the first layers of the 3d print.

The build plate 18 in the example of FIG. 2 is provided with a number of ridges 11 and grooves or indents/recesses 12. The ridges 11 and grooves or indents 12 are examples of surface irregularities which can be manufactured on the build plate 18 on purpose. By providing a pattern of a predefined sequence of a plurality of straight ridges and/or grooves along the build surface 10, the build plate 18 can be identified using the method according to some embodiments of the invention. The ridges and/or grooves can be arranged in parallel so as to form a bar coding.

Alternatively, the predefined pattern of surface irregularities may comprise a predefined sequence of a plurality of circular ridges and/or circular grooves along the build surface 10 to form a specific dot coding. It is also conceivable that the predefined pattern of surface irregularities comprises a sequence of a plurality of letter and/or number shaped ridges 11 and/or grooves 12 along the build surface 10 to form a letter coding.

The controller 7 may be arranged to deposit a single layer of material along a predetermined trajectory and to determine the local height of the build plate 18 at a plurality of locations on the trajectory. An example of such a trajectory is shown in FIG. 3 which shows a top view of the build plate 18 having a trace of filament material 26 deposited along its edges. The trace also crosses a pattern of surface irregularities 35. This loop-shaped trace can be used to scan an identification code patterned on the surface of the build plate 18, and also determine the local height of the surface of the build plate 18 at the edge of the build plate 18.

During the height measurements, the nozzle 4 is moving in the X-Y plane (also referred to as nozzle plane) to obtain the height data for the required X,Y positions on the build surface 10. In this fashion, height, tilt, curvature and non-flatness of the surface can be assessed. The local heights values can be used to generate a simple height map sufficient to determine a tilt or curvature of the build plate 18 relative to the nozzle plane. Such a determined tilt or curvature can be used to directly generate a height map, or it may be added to an already existing map of the build surface 10.

The height map of a build plate can be used in future prints to generate better toolpaths so as to improve the reliability of the first layers of the 3D print. The controller 7 may be arranged to first identify a build plate by depositing a layer over the pattern of surface irregularities 31, and then search for a stored height map corresponding to the identification code, and then use the stored height map to correct the local heights during printing an object.

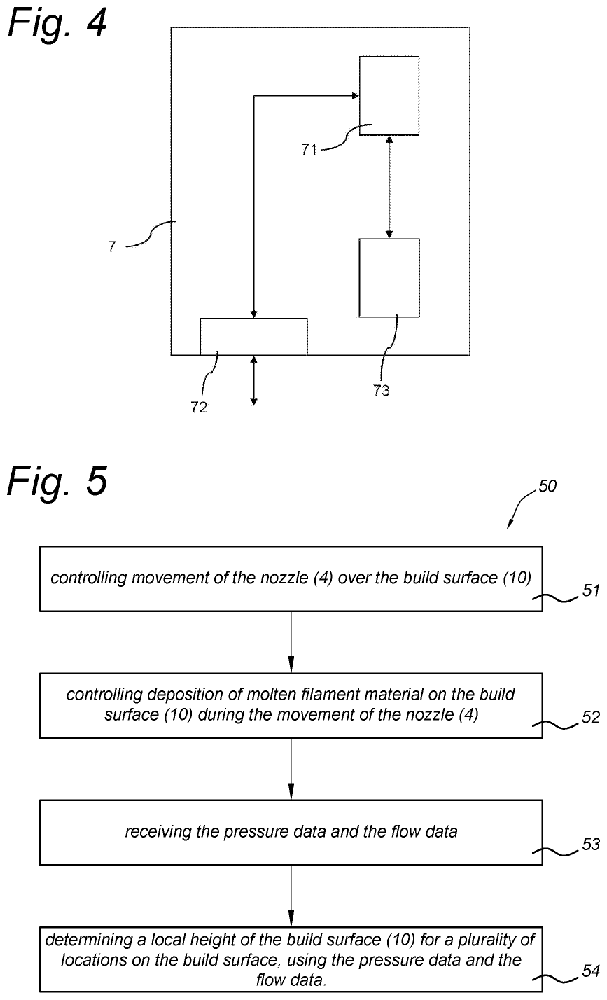

FIG. 4 schematically shows the controller 7 according to an embodiment. The controller 7 comprises a processing unit 71, an I/O interface 72 and a memory 73. The processing unit 71 is arranged to read and write data and computer instructions from the memory 73. The processing unit 71 is also arranged to communicate with sensors and other equipment via the I/O interface 72. The memory 73 may comprise a volatile memory such as ROM, or a non-volatile memory such as a RAM memory, or any other type of computer-readable storage.

FIG. 5 shows a flow chart of the method 50 of determining a local height of a build surface of a build plate 18 according to some embodiments of the invention. The method 50 comprises a step 51 of controlling movement of the nozzle 4 over the build surface 10. The method further comprises a step 52 of controlling deposition of molten filament material on the build surface 10 during the movement of the nozzle 4. The method further comprises a step 53 of receiving the pressure data and the flow data. The method 50 also comprises a step 54 of determining a local height of the build surface 10 fora plurality of locations on the build surface 10, using the pressure data and the flow data. It is noted that in FIG. 5 the steps are drawn as consecutive steps, but the controller 7 may actually perform some or all of the steps simultaneously. So while moving the print head 2 and controlling the deposition of filament on the build surface 10, the controller 7 may receive input from the sensors and determine the local height of the build plate 18.

In an embodiment, the controller 7 is arranged to vary a flow of the filament material 5 into the print head 2 during printing in such a way as to maintain a constant pressure in the melting chamber 22. When the nozzle 4 moves along the surface in the nozzle plane, a distance between the nozzle 4 and the build surface 10 may vary due to irregularities or surface curvatures. In both cases, the back pressure experienced in the melt chamber 22 will change. These changes will be measured and used in a control loop to immediately try to maintain the previous pressure in the melt chamber. In this embodiment, this is done by varying the feed flow. The controller 7 will then determine the local height based on the varying feed flow.

In another embodiment, the controller 7 is arranged to let a pressure in the melt chamber 22 vary during printing in such a way as to maintain a constant flow of the filament 5, wherein the controller is arranged to determine the local height based on the varying pressure.

In another embodiment, the controller 7 is arranged to vary the distance d, see also FIG. 2, between the nozzle 4 and the build surface 10 during printing in such a way as to maintain a constant flow of the filament 5 and a constant pressure in the melt chamber 22, wherein the controller 7 is arranged to determine the local height based on the varying distance d.

The pressure in the melt chamber 22 can be measured using the pressure sensor 34. In this way the pressure is measured in a direct way. The pressure could also be measured in indirect ways, such as using a force sensor arranged to measure a force sensed by the filament 5, a force sensor arranged to measure a force acting on the nozzle, such as the sensor 32. Other types of indirect measurements are possible such as measuring a force acting on the build plate 18 using a force sensor 33.

Different control schemes can be used by the controller 7, and also the controller 7 could be arranged to use one of the embodiments described above, or it may be arranged to switch between control schemes optionally depending on user input or nozzle type or material type used.

It is noted that additional calibration and linearization of the measured height map determined by the method described above, may be performed to obtain more accurate results. By repeating the procedure and using new data each step, the precision of the local height values will improve. Calibration can compensate for (temperature dependent) viscosity changes of material and nozzle geometry variations. In an embodiment, the calibration of the nozzle comprises printing in mid-air having the build plate for removed from the nozzle so as to avoid any back pressure. In this way it is possible to characterize the nozzle-material combination and find the pressure and flow data to be used as input for the method described above.

The present invention has been described above with reference to a number of exemplary embodiments as shown in the drawings. Modifications and alternative implementations of some parts or elements are possible, and are included in the scope of protection as defined in the appended claims. It should be noted that the above-mentioned embodiments illustrate rather than limit the invention, and that those skilled in the art will be able to design many alternative embodiments. For example, the nozzle 4 may be movable in the X-direction and Z-direction while the build plate 18 is moving in the Y direction. Or the nozzle 4 may be movable in the X-direction while the build plate 18 is moving in the Y direction and Z-direction. Or the nozzle 4 may be fixed while the build plate 18 is movable in the X-direction, Y-direction and Z-direction.

Furthermore, the device 1 may be a direct feeder 3D printer system wherein the filament feeder 3 is arranged in or near the print head.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. A fused filament fabrication device, the device comprising:
a print head comprising a melt chamber and a nozzle, the print head being movably arranged relative to a build surface (10) in at least two perpendicular directions;
a feeder arranged to feed filament material to the print head;
a sensor arranged to directly or indirectly measure a pressure in the melt chamber (22, the sensor producing pressure data;
a flow sensor arranged to measure a flow of filament into the print head to obtain flow data;
a controller arranged for:
a) controlling movement of the nozzle over the build surface-;
b) controlling deposition of molten filament material on the build surface during the movement of the nozzle;
c) receiving the pressure data and the flow data, and
d) determining a local height of the build surface for a plurality of locations on the build surface, using the pressure data and the flow data.

2. The device according to claim 1, wherein the controller is arranged to vary a flow of the filament material into the print head during printing in such a way as to maintain a constant pressure in the melting chamber, wherein the controller is arranged to determine the local height based on the varying feed flow.

3. The device according to claim 1, wherein the controller is arranged to maintain a constant flow of the filament while letting a pressure in the melt chamber vary during printing, wherein the controller is arranged to determine the local height based on the varying pressure.

4. The device according to claim 1, wherein the controller is arranged to vary the distance (d) between the nozzle and the build surface during printing in such a way as to maintain a constant flow of the filament and a constant pressure in the melt chamber, wherein the controller is arranged to determine the local height based on the varying distance (d).

5. The device according to claim 1, wherein the controller is arranged to deposit a single layer of material along a predetermined trajectory and to determine the local height of the build plate at a plurality of locations on the trajectory.

6. The device according to claim 1, wherein the controller is arranged to generate a height map of the build plate using the determined local height of the plurality of locations.

7. The device according to claim 1, wherein the build surface comprises a predefined pattern of surface irregularities representing an identification of the build plate, and wherein the controller is arranged to deposit a single layer of material over the predefined pattern of surface irregularities, and to determining the local height of the predefined pattern of surface irregularities, and to translate the determined local height of the predefined pattern into an identification code for the build plate.

8. A method of determining a local height of a build surface of a build plate for use in a fused filament fabrication device, the device comprising a print head comprising a melt chamber and a nozzle, the device further comprising a feeder arranged to feed filament material to the print head, a sensor arranged to directly or indirectly measure a pressure in the melt chamber to obtain pressure data, and a flow sensor arranged to measure a flow of filament into the print head to obtain flow data, the method comprising:
a) controlling movement of the nozzle over the build surface;
b) controlling deposition of molten filament material on the build surface during the movement of the nozzle;
c) receiving the pressure data and the flow data, and
d) determining a local height of the build surface for a plurality of locations on the build surface, using the pressure data and the flow data.

9. The method of determining a local height according to claim 8, the method comprising: e) identifying the build plate using the determined local height of the build surface.

10. A computer program product comprising code embodied on a computer-readable storage and configured so as to perform the method according to claim 8.
